(19) United States
(12) Patent Application Publication
(10) Pub. No.: US 2021/0289170 A1
(43) Pub. Date: Sep. 16, 2021

(54) SYSTEMS AND METHODS FOR CAMERA FEEDS

(71) Applicant: EDX Technologies, Inc., Austin, TX (US)

(72) Inventors: Roger Ray Skidmore, Austin, TX (US); Eric Reifsnider, Raleigh, NC (US)

(21) Appl. No.: 16/618,229

(22) PCT Filed: May 31, 2018
(86) PCT No.: PCT/US2018/035451

§ 371 Date: Nov. 29, 2019

Related U.S. Application Data
(60) Provisional application No. 62/512,768, filed on May 31, 2017.

(51) Int. Cl. H04N 7/18; G08B 13/196

(52) U.S. Cl. CPC H04N 7/181; G08B 13/19645

(57) ABSTRACT

Systems and methods of automated and efficient camera selection are provided as useful tools for first responders and other contexts.

### CROSS-REFERENCE TO RELATED APPLICATIONS

This application claims the benefit of U.S. provisional patent application No. 62/512,768, filed May 31, 2017, the complete contents of which are herein incorporated by reference.

### FIELD OF THE INVENTION

The invention generally pertains to configuring and using camera feeds and, in particular, time-sensitive selection and display of camera feeds using location information and virtual models.

### BACKGROUND

Cities today contain hundreds or thousands of cameras. Many of the cameras are permanent or semi-permanent installations, such as traffic cameras, street cameras, and security cameras. Other cameras are mobile cameras, such as cellphone cameras, dash cams, and wearable cameras (e.g., worn by police officers), among others. Entities such as law enforcement agencies may have access to hundreds of camera feeds generated by this veritable constellation of cameras distributed throughout the city. However, the utility of these cameras—generally referred to herein as the camera constellation for ease of discussion—can be limited without tools to organize, manage, and manipulate the correspondingly large numbers of camera feeds.

The existence of the camera constellation gives rise to the possibility of having “eyes on” a target prior to a human actually arriving at the location of the target. This is of particular interest to first responders such as law enforcement officers, firemen, EMTs, and paramedics. Emergency situations are extremely time sensitive, and the faster first responders can understand the circumstances of a developing emergency, the better their response capabilities. For instance, prior to the camera constellation, a police officer responding to a 9-1-1 call for a crime in progress may have little knowledge of the events related to the crime which are transpiring while the officer is driving to the scene of the crime. Say that a traffic camera or security camera happens to be situated a hundred yards from the address where the crime is reportedly taking place. Support personnel for the officer could, if aware of the camera and equipped to access its feed, view the feed to monitor whether or not suspects are still at the scene of the crime or are attempting to leave. The problem, however, is that a crime can happen virtually anywhere in a city, and first responders are not equipped to know which camera or cameras among hundreds or thousands of cameras in the camera constellation actually provide a view of the location where a crime or some other emergency has suddenly begun to transpire. In practice, the cameras which are of relevance to a singular crime or other emergency incident are only a tiny subset of all the cameras in the constellation. When first responders lack efficient means with which to select the relevant subset of cameras for viewing, the utility may be altogether lost. That is to say, if the camera selection is too complex or too slow an operation, the emergency will be over before the subset of relevant cameras is even identified.

### SUMMARY

An object of some embodiments of the invention is to efficiently select for display to users a subset of available camera feeds which correspond with a real world location. The real world location may be designated in connection with a virtual model designed to model a real world space such as a city.

An exemplary implementation of the invention is configured for first responder assistance. In first responder and other emergency contexts, response time is very important. After receiving an emergency call (e.g., a 9-1-1 call in the U.S.) or notification from a phone, a location of the device is determined. The location determination may be achieved by, for example, cell tower triangulation or by receipt of GPS data initially generated at the device itself. After the location information has been determined or obtained, the location is compared against a table of available camera feeds. The table links camera identifications with location codes that indicate what locations lie within each cameras view or viewing range.

Cameras having a location code which matches the determined location of the emergency are selected, and their camera feeds are automatically assembled together for display to a user. Feeds from other cameras which do not have matching location codes may be hidden or deprioritized in such a way that conveys to a user which subset of camera feeds are those which have location codes matched to the emergency location. Accordingly, the user, which in this case is a first responder agent, is given a finite and manageable set of camera feeds which all correspond with the emergency location in question. The process clears the selected camera feeds and is repeated for emergencies involving a changing location and for each new emergency response for which it is employed.

A chief advantage of some exemplary embodiments is efficiency and minimization of response time. In some cases, embodiments provide substantially real-time updates of camera feed selection in response to an update to the target location.

Another advantage of some embodiments is the ability to track a moving object across camera feeds. Unlike tracking processes which use image processing of camera feeds to track the location of a moving object (e.g., a crime suspect evading arrest), embodiments of the present invention use location information of the moving object to select and update selection of cameras which have view of the moving object. In more detail, if for example a suspect has a mobile phone transmitting a signal which includes location information (or information from which location information is determinable), that location information is compared against a database of location coded cameras. Only cameras having a location code which matches the most up-to-date location information of the suspect's mobile phone have their feeds displayed to a user. A user in this type of scenario may be law enforcement officer (LEO), for example. The selection of camera feeds which are actually displayed updates in real time with changes in the location of the moving mobile device of the suspect.

Some embodiments involve a virtual model such a three-dimensional (3D) model which is modeled after a real world geographic space, such as a town or city. One or more databases store information that describes what each camera (e.g., traffic camera, street camera, security camera, etc.) views relative to the 3D model. After a location within the virtual model is selected or pinpointed as a target, only real world cameras/camera feeds are selected which have a view of a the real world space corresponding with the virtual space indicated by the pinpointed location. The video feeds of those specific real world cameras are selected for display to a user while remaining camera feeds are excluded. In short, camera feeds which show real world spaces are matched to locations within a virtual model. This permits alignment of the views of real cameras with a virtual model.

### BRIEF DESCRIPTION OF THE DRAWINGS

FIG. 1 is a schematic of a system for automated camera feed selection and display.

FIG. 2 is an exemplary method performed by the system of FIG. 1.

FIG. 3 is a map for part of a city that has a camera constellation.

### DETAILED DESCRIPTION

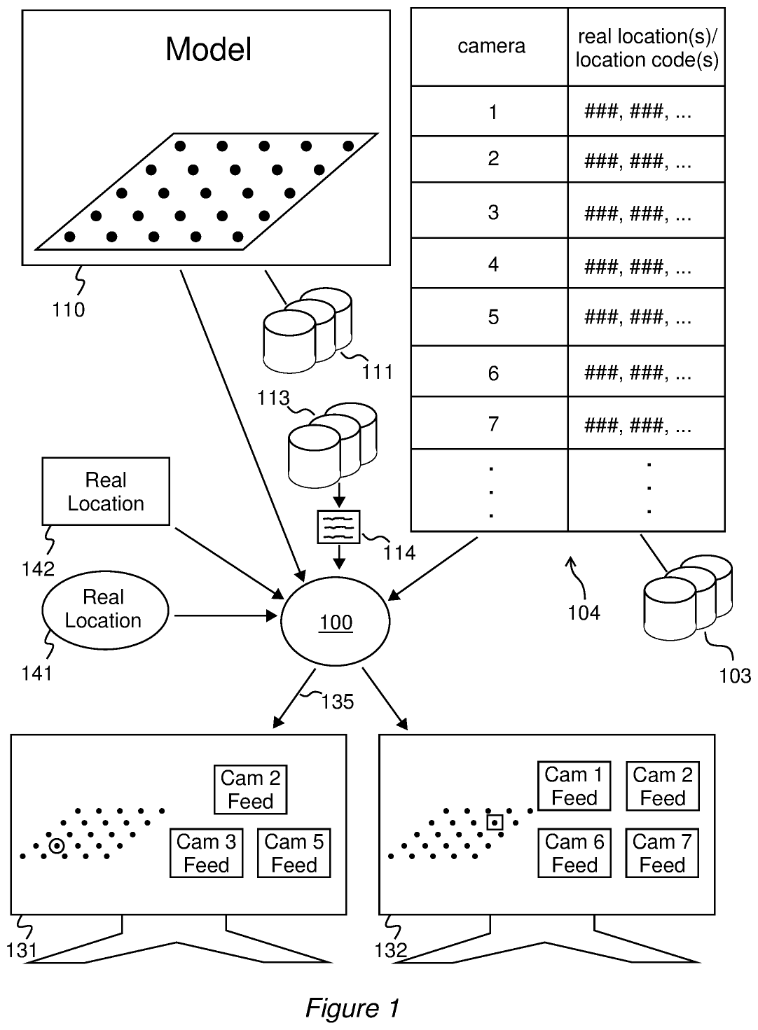

FIG. 1 is a schematic of a system for automated camera feed selection, such as for first responder assistance. The system is configured to automatically select a subset of cameras/camera feeds from a plurality of cameras/camera feeds. The plurality of cameras is, for example, a camera constellation of a city or town. One or more databases 103 are configured to store one or more tables 104 which link camera identifications with location codes that indicate what locations lay within each cameras view or viewing range. The locations may be expressed in GPS coordinates or coordinate ranges, for example.

For a given camera, its “location codes” are IDs of locations which lie within the view of the given camera. The precise type of ID may vary among embodiments. Just as a particular human may be IDed by a variety of codes (social security number, telephone number, legal name, DNA sequence, etc.), so too may variability exist among or within embodiments on the precise manner in which a location is IDed. “Location code” may therefore be treated as an umbrella term encompassing a wide variety of forms of identifying a location. Two common location code types are mailing address and GPS coordinates. Note that the location of a camera itself would generally not be among the location codes for that camera, because relatively few cameras have a view of themselves (absent a nearby reflecting surface like a mirror).

A “location coded camera” is a camera for which one or more location codes have been determined and in all likelihood stored.

A model 110 is a virtual model of a real world physical space, such as a town or city (e.g., NYC/Manhattan). Data used or usable to generate the model is stored on one or more databases 111. The virtual model may be three dimensional, and may represent some or all aspects of the corresponding real world space (e.g., terrain and terrain features such as hills, mountains, foliage, waterways, caves, etc., and man-made constructions such as buildings (both interior and exterior), tunnels, bridges, roadways, etc.). An exemplary 3D virtual model has virtual locations which are configured to correspond with real world locations. Real world geography, locations, landscapes, landmarks, structures, and the like, natural or man-made, may be reproduced within the virtual world in like sizes, proportions, relative positions, and arrangements as in the real world. For example, a 3D virtual model of New York City would in fact resemble New York City in many respects, with matching general geography and landmarks. Within the virtual world, virtual objects may be created (e.g., instantiated) at virtual locations. Since a virtual location corresponds with a real world location, a virtual object at a given virtual location becomes associated with a particular real world location that corresponds with the given virtual location. Data stored by or with the virtual object is also inherently associated with the particular real world location. A virtual object stored in, with, or with reference to a virtual model may not inherently take a particular state as far as sensory modalities are concerned. For example, a virtual object may not have a particular appearance. Indeed, a virtual object may have no appearance at all, and in essence be “invisible” to an unaided human eye. Note that a virtual model need not be displayed to a human to exist. Not unlike a harddrive storing photographs which are not actively being viewed, the data describing a virtual model may be stored sight unseen and accessed by one or more processors performing a method according to the invention. For consistency, a common (e.g., single) virtual model is preferably shared across all cameras (e.g., all cameras which a particular user has at his or her disposal).

At least some of the cameras identified in table 104 have real world locations which correspond with virtual world locations in the model 110. For purposes of illustration, FIG. 1 shows a grid of dots as a schematic representation of a space in the virtual model 110. The space includes at least twenty-five identifiable locations, each dot corresponding with one of these twenty-five locations. For example, each dot could identify the location of an intersection in a city that has gridded streets. It should be appreciated that this simplistic representation serves an illustrative purpose for actual virtual models that are generally more complex. One or more processors 100 are configured to execute instructions 114 stored on a storage medium 113. The storage medium 113 which may be one or more databases, for example. The processors 100 perform the central operations which, starting with a target real world location 141 or 142, ultimately result in a signal being generated which instructs a display device 131 or 132 to show a specific subset of camera feeds from a plurality of camera feeds that are available to a user.

The system in FIG. 1 is configured to provide signals which direct or instruct the visual outputs on display devices like displays 131 and 132. These signals and the corresponding visual outputs are based on targeted real location inputs 141 or 142.

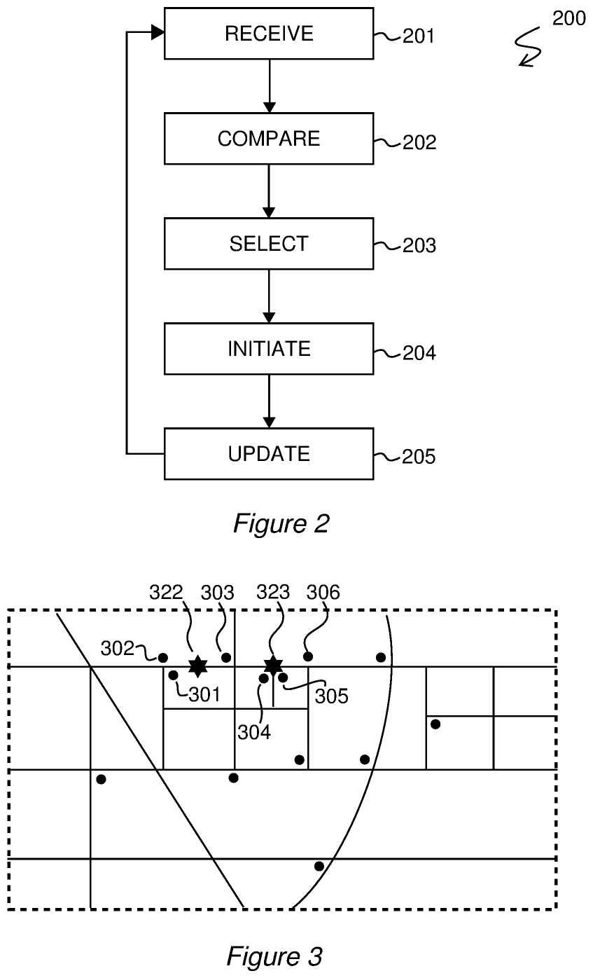

Referring now to FIG. 2, an exemplary procedure 200 performed by the system of FIG. 1 will now be described. A notification of a target real world location 141 is first received (block 201). Initial designation of a real world location 141 may be by any one of a variety of means. For instance, a mobile device such as a mobile phone, tablet, laptop, or other device which is GPS-enabled or which may be triangulated with a mobile communication network may transmit a signal which specifies a location or is usable to specify a location 141. Alternatively, a user of model 110 may select a location within the model (e.g., by entering latitude and longitude coordinates into a data input box, or by clicking on a location within the model, or by some other means). The selected virtual location in the model corresponds with real world location 141.

Notification of the real world location 141 is ultimately received by the one or more processors 100 which then perform a comparison of such target location with a table 104 of location coded cameras (block 202). Table 104 may in some embodiments be arranged as a plurality of tables, which in any case link camera IDs with location information corresponding to each camera. The location codes are locations that are actually viewable with the camera. A location code therefore may define a small geographic space as defined by a frustum, for example. Because camera viewports are frequently rectangular, the frustum of a camera is usually a truncated four-sided (e.g., rectangular) pyramid. For viewports of other shapes (e.g., circular), the frustum may have a different base shape (e.g., a cone). The boundaries or edges of a frustum 100 may be defined according to a vertical field of view 101 (an angle, usually expressed in degrees), a horizontal field of view (an angle, usually expressed in degrees), a near limit (a distance or position), and a far limit (a distance or position). The near limit is given by a near clip plane 103 of the frustum. Similarly, the far limit is given by a far clip plane 104 of the frustum. Besides these boundaries, a frustum also generally includes position and orientation. In short, an exemplary frustum includes position, orientation, field of view (horizontal, vertical, and/or diagonal), and near and far limits. Position and orientation may be referred to collectively as “pose.”

The comparison of the real location 141 with the location codes from table(s) 104 results in a subset of cameras for which there is a match in location 141 and location code in the table. Each camera in the table 104 corresponds with a camera feed, and only the feeds of the cameras which matched the location 141 are of immediate interest according to process 200. This finite subset of camera feeds which have matching location information for target real world location 141 are selected at block 203 for display. Only the subset of camera feeds is selected, to the exclusion of other cameras/feeds from table 104. The computers 100 initiate a signal 135 at block 204 which is transmitted to a display device 131. According to the example of FIG. 1, target real location 141 was matched to cameras/feeds 2, 3, and 5, and only these three feeds are shown on display 131, to the exclusion of other possible feeds. In some embodiments, the virtual location in model 110 that correspond with the real location 141 may be displayed simultaneously with the selected camera feeds, as is the case in display 131 in FIG. 1.

A target location may change over time, either because an emergency involves a changing location, or because a user has changed attention to a completely different emergency situation transpiring at a different location. The second target real world location 142 is received by the computers 100 as part of an update procedure 205. The update procedure 205 repeats steps 201 through 204 to keep the selected and displayed camera feeds up to date. In FIG. 1, the first target real location 141 was matched to camera feeds 2, 3, and 5. However, the second target real location 142 is matched to camera feeds 1, 2, 6, and 7. Therefore, display 132 (which may the same or different as display 131) shows only camera feeds 1, 2, 6, and 7 as an updated subset of camera feeds. FIG. 1 also shows how the co-displayed location in the virtual model 110 has been updated to reflect the change in location, too.

FIG. 3 shows a map that illustrates a camera constellation and the need for efficient, automated selection processes for selecting a subset of camera feeds from the constellation for display to a user. In the figure, black lines are roadways and the black dots are traffic or security cameras. Assume for the sake of illustration that a developing emergency occurs at real world location 322 and is brought to the attention of first responders. A system such as that of FIG. 1 receives notification of location 322 and immediately compares it against the location codes of all available cameras. The system matches the location 322 to only cameras 301, 302, and 303. Therefore, the system initiates a signal for display of only these three camera feeds to the first responder reacting to the emergency which has arisen at location 322.

Now assume that the emergency involves a moving location, such as a car chase of a criminal suspect. At a subsequent moment in time, the target location has changed from location 322 to location 323, about a block and half east of the original location. The system runs an updated matching and selection process based on the new location 323. Now the matching process shows cameras 303, 304, 305, and 306 as having view of the target location. The display of the first responder is therefore updated to no longer show the subset of camera feeds from cameras 301, 302, and 303 but instead is shown camera feeds from cameras 303, 304, 305, and 306. Notably the remainder of the available cameras (represented as dots in FIG. 3) are not of interest to the first responder in this instance and their feeds are excluded from display.

The system can utilize full knowledge of the virtual model of the environment in determining which cameras have visibility to a given location. For example, if a given camera's view of a location is blocked by a building or terrain feature (e.g., a hill) whose physicality is captured within the virtual camera, the system can determine the camera does not actually have a view of the desired location by comparing the view in the virtual model, and that camera may be excluded from the list chosen for display. Likewise, if a given camera's view of a location is blocked by foliage that is captured by the virtual model, the system can determine that the obstructing object is foliage, which may be not fully block the view. In this case, the system may determine that the camera could still have a view of the location, albeit a potentially partially or fully obstructed view.

If the number of cameras that are matched with the target location at block 202 is large (e.g., above some pre-defined threshold such as four, five, or six) the selection at block 203 may include only a portion of the matching cameras. As an example, if six cameras match a target location but a user has pre-designated a setting to see no more than three camera feeds at a time, three of the six matched cameras will be used as the subset included in the initiated signal (block 204) and displayed.

The display device (e.g., displays 131 and 132 in FIG. 1) may be any electronic device capable of displaying visual content to a user. For instance, the display device may be a mobile phone, tablet, laptop, head-mounted display (HMD), heads up display (HUD), or some other device.

In general, image processing is not required in exemplary embodiments. Image processing may nevertheless be used to provide various additional advantages. For instance, the direction a camera is facing may be determined by processing the video feed from the camera.

Location information may be absolute (e.g., latitude, longitude, elevation, and a geodetic datum together may provide an absolute geo-coded position requiring no additional information in order to identify the location), relative (e.g., “2 blocks north of latitude 30.39, longitude −97.71 provides position information relative to a separately known absolute location), or associative (e.g., “right next to the copy machine” provides location information if one already knows where the copy machine is; the location of the designated reference, in this case the copy machine, may itself be absolute, relative, or associative). Absolute location involving latitude and longitude may be assumed to include a standardized geodetic datum such as WGS84, the World Geodetic System 1984. In the United States and elsewhere the geodetic datum is frequently ignored when discussing latitude and longitude because the Global Positioning System (GPS) uses WGS84, and expressions of latitude and longitude may be inherently assumed to involve this particular geodetic datum. For the present disclosure, absolute location information may use any suitable geodetic datum, WGS84 or alternatives thereto.

Some embodiments of the present invention may be a system, a device, a method, and/or a computer program product. A system, device, or computer program product may include a computer readable storage medium (or media) having computer readable program instructions thereon for causing a processor to carry out aspects of the present invention, e.g., processes or parts of processes or a combination of processes described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Processes described herein, or steps thereof, may be embodied in computer readable program instructions which may be paired with or downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and in various combinations.

These computer readable program instructions may be provided to one or more processors of one or more general purpose computers, special purpose computers, or other programmable data processing apparatuses to produce a machine or system, such that the instructions, which execute via the processor(s) of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described herein in connection with exemplary embodiments and features, one skilled in the art will recognize that the invention is not limited by the disclosure and that various changes and modifications may be made without departing from the scope of the invention as defined by the appended claims.

What is claimed is:

1. A method, comprising
receiving notification of a target real world location;
comparing, by one or more processors, the target real world location with a table of location coded cameras corresponding with a plurality of camera feeds;
selecting, by the one or more processors, automatically from the plurality of camera feeds a subset of camera feeds, the subset including only camera feeds of cameras with location codes matching the target real world location; and
initiating a signal to display the selected subset of camera feeds.

2. The method of claim 1, further comprising updating the selected subset of camera feeds in response to receiving an updated target real world location.

3. The method of claim 1, wherein the real world location is GPS coordinates.

4. The method of claim 1, wherein the notification received in the receiving step is associated with a request for first responder assistance.

5. A system, comprising
a storage medium comprising computer readable instructions;
one or more processors configured to executed the computer readable instructions such that, upon execution by the one or more processors, the computer readable instructions cause the one or more processors to perform
receiving notification of a target real world location;
comparing the target real world location with a table of location coded cameras corresponding with a plurality of camera feeds;
selecting automatically from the plurality of camera feeds a subset of camera feeds, the subset including only camera feeds of cameras with location codes matching the target real world location; and
initiating a signal to display the selected subset of camera feeds.

6. The system of claim 5, further comprising one or more display devices configured to receive the signal and display the selected subset of camera feeds.

7. The system of claim 5, wherein the notification received by the one or more processors is associated with a request for first responder assistance.
